(19) United States
(12) Patent Application Publication
(10) Pub. No.: US 2017/0027201 A1
(43) Pub. Date: Feb. 2, 2017

(54) METHOD FOR MANUFACTURING FERMENTED FOOD COMPOSITION

(71) Applicant: KANEKA CORPORATION, Osaka-shi, Osaka (JP)

(72) Inventors: Airo TATEGAKI, Takasago-shi, Hyogo (JP); Minoru UEDA, Takasago-shi, Hyogo (JP)

(21) Appl. No.: 15/302,746

(22) PCT Filed: Mar. 20, 2015
(86) PCT No.: PCT/JP2015/058621

§ 371 Date: Oct. 7, 2016

(30) Foreign Application Priority Data
Apr. 11, 2014 (JP) 2014-081847

(51) Int. Cl. A23L 11/00; A23L 5/20; A23K 10/30

(52) U.S. Cl. CPC A23L 11/09; A23K 10/30; A23L 5/20; A23V 2002/00

(57) ABSTRACT

According to a manufacturing method of the present invention, Class 2 food allergens can be decomposed even if a protease is not used, and thus a manufacturing cost is inexpensive, and a food composition having a reduced content of Class 2 food allergens can be provided without using salt water which has an effect on the taste. The fermented food composition, obtained by the manufacturing method of the present invention, has a sufficiently reduced content of the Class 2 food allergens, and thus even those who contracts pollinosis or latex allergy can safely take it. The fermented food composition is tasty, and thus it can be used instead of food having the Class 2 food allergens.

### TECHNICAL FIELD

The present invention relates to a method for manufacturing a fermented food composition having reduced Class 2 food allergens, and a fermented food composition which is safe and tasty.

### BACKGROUND ART

While high attention is focused on the safety of food, an increase or diversity of food allergy patients becomes a big social issue. The food allergy has hitherto been recognized that sensitization is caused by orally taking a specific protein contained in food, and then symptoms such as hives and diarrhea are attacked when the food is taken again.

Recently, in people contracting pollinosis or latex allergy, however, the number of people who develop an allergy such as itch or swelling (Class 2 food allergy) on lips or throats is increased when they take fruit, vegetables, and beans. For example, in medical settings, the number of cases in which people contracting Alnus pollinosis take food such as soybean, peach, apple, tomato, or kiwi, then develop the Class 2 food allergy, and consult a doctor is increased. In addition, there are many cases in which the patients consulting a doctor with the Class 2 food allergy do not recognize that they contract the Class 2 food allergy, and thus a problem in which they have serious allergy symptoms occurs. The contributor of the Class 2 food allergy may include Class 2 food allergens contained in plants and fruits. It has been proved that the allergens have high homology with allergens in pollen or latex, and thus the allergens are recognized as allergens of pollen in the body of a person contracting the pollinosis, whereby the allergy symptom is induced.

Meanwhile, a method in which allergen-reducing wheat flour is manufactured using a protease or salt water (Patent Document 1), a method in which allergen-reducing rice is manufactured using a protease derived from lactic acid bacteria (Patent Document 2), and a method in which soybean hypocotyl is fermented using enteric bacteria to reduce a content of allergens in soybean have hitherto been disclosed as a method for solving the food allergy.

### CITATION LIST

### Patent Literature

Patent Document 1: JP-A No. H10-108636

Patent Document 2: JP-A No. H11-009202

Patent Document 3: JP-A No. 2012-228252

### SUMMARY OF INVENTION

### Technical Problem

According to the method described in Patent Document 1 or 2 for example, however, an enormous cost is necessary because of the use of the protease, and it is concerned that the obtained fermented product is bitter because the salt water is added to the food.

In order to solve the problems in the prior art documents, the present inventors have studied, for example, the reduction of the content of the Class 2 food allergens when the food having the Class 2 food allergens is fermented with the lactic acid bacteria, as described in the prior art document 3. They have found a problem in which when the food having the Class 2 food allergens is fermented with the lactic acid bacteria alone, the Class 2 food allergens are not sufficiently decomposed, and the fermentation odor of the fermented product becomes stronger and the taste is deteriorated.

In view of the problems described above, the present invention aims at providing a method for manufacturing a tasty fermented food composition in which the content of the Class 2 food allergens, which are the protein causing the Class 2 food allergy, are reduced.

### Solution to Problem

In order to solve the problems described above, the present inventors have repeated a painstaking study; as a result, they have found that when lactic acid bacteria having a leucine aminopeptidase activity with a specific range are added to food having Class 2 food allergens and the fermentation is performed under a specific pH condition using a bivalent metal compound, the content of the Class 2 food allergens in the food is reduced and a tasty fermented food composition can be obtained; and have completed the present invention.

The present invention provides the followings;

(1) A method for manufacturing a fermented food composition by fermenting food having Class 2 food allergens, containing the following steps (a) and (b);
(a) a step of adding at least lactic acid bacteria having a leucine aminopeptidase activity of 75 units or more but 720 units or less and a bivalent metal compound to food having Class 2 food allergens and fermenting the resulting food while adjusting the pH of the food to 4.0 or more but less than 8.5; and
(b) a step of recovering a fermented food composition obtained by the fermentation.
(2) The manufacturing method according to (1), wherein the bivalent metal compound is at least one compound selected from the group consisting of a magnesium compound, a calcium compound, and a zinc compound.
(3) The manufacturing method according to (1) or (2), wherein the bivalent metal compound is added in an amount of 2 mmol/L or more but less than 1 mol/L.
(4) The manufacturing method according to (3), wherein the bivalent metal compound is added in an amount of 20 mmol/L or more but 150 mmol/L or less.
(5) The manufacturing method according to any of (1) to (4), wherein the Class 2 food allergen is a protein containing an amino acid sequence having 20% or more of a sequence identity with an amino acid sequence of BetV1 and/or BetV2.
(6) The manufacturing method according to any of (1) to (5), wherein the food having the Class 2 food allergens is soybean and/or processed food of soybean.
(7) The manufacturing method according to any of (1) to (6), wherein the lactic acid bacteria are at least one of bacteria selected from the group consisting of lactic acid bacteria belonging to Lactobacillus, Lactococcus, Leuconostoc, Pediococcus, and Enterococcus.
(8) The manufacturing method according to any of (1) to (7), wherein the fermentation is performed for 8 hours or more but 36 hours or less.
(9) A fermented food composition obtained by the manufacturing method according to any of (1) to (8).
(10) Food containing the fermented food composition according to (9).
(11) Feed containing the fermented food composition according to (9).

### Advantageous Effects of Invention

According to the manufacturing method of the present invention, even if a protease is not used, the Class 2 food allergens can be decomposed, and thus the cost for manufacturing is inexpensive, and a food composition having the reduced content of the Class 2 food allergens can be provided without using salt water having an effect on the taste.

In addition, the fermented food composition obtained by the manufacturing method of the present invention has the sufficiently reduced content of the Class 2 food allergens, and thus it can be safely taken by people contracting pollinosis or latex allergy, and the composition can be replaced for food having Class 2 food allergens because the composition is tasty.

### DESCRIPTION OF EMBODIMENTS

The present invention is explained in detail below.

The present invention relates to a method for manufacturing a fermented food composition by fermenting food having Class 2 food allergens.

The Class 2 food allergen in the present invention refers to a protein having a high sequence identity of an amino acid sequence with an allergen contained in pollen or latex, and is mainly contained in plants or fruits. If the sequence identity with a specific allergen is 20%, an allergy symptom may sometimes be induced, and thus the Class 2 food allergen in the present invention refers to a protein having 20% or more of the sequence identity of the amino acid sequence with the allergen contained in the pollen or the latex.

Specifically, it may include the following proteins. A protein containing an amino acid sequence having 20% or more, preferably 30% or more, more preferably 40% or more, still more preferably 47% or more, of a sequence identity with an amino acid sequence of BetV1 described in the sequence number 1, which is a main antigen of Betula alba pollen; and a protein containing an amino acid sequence having 20% or more, preferably 50% or more, more preferably 60% or more, still more preferably 74% or more, of a sequence identity with an amino acid sequence of BetV2 described in the sequence number 2, which is a main antigen of Betula alba pollen. More specifically, the Class 2 food allergens may include PR-10 family proteins and profilin family proteins, which have 20% or more of a sequence identity with an amino acid sequence of BetV1 and/or BetV2. Especially, it may include Glym4, which is a PR-10 family protein, has 47% of a sequence identity with an amino acid sequence of BetV1, and contains an amino acid sequence described in the sequence number 3, which is a protein derived from soybean; and Glym3, which is a profilin family protein, has 74% of a sequence identity with an amino acid sequence of BetV2, and contains an amino acid sequence described in the sequence number 4, which is a protein derived from soybean.

Proteins having 85% or more, more preferably 90% or more, still more preferably 95% or more, of a sequence identity with an amino acid sequence of Glym4 or Glym3 are included in the Class 2 food allergens in the present invention.

The food having the Class 2 food allergens in the present invention refers to food which induces Class 2 food allergy. The food which induces the Class 2 food allergy may include, for example, Rosaceae food such as apple, peach, strawberry, pear, loquat, or cherry; Cucurbitaceae food such as melon, watermelon, or cucumber; soybean, kiwi, orange, yam, mango, avocado, hazelnut (hazel), carrot, celery, potato, tomato, burdock, walnut, almond, coconut, peanut, liche, onion, rice, wheat, mustard, paprika, coriander, red pepper, cumin, and the like. Of these, apple, peach, strawberry, pear, loquat, cherry, melon, watermelon, cucumber, soybean, kiwi, orange, yam, mango, avocado, hazelnut (hazel), carrot, celery, potato, tomato, burdock, walnut, almond, coconut, peanut, liche, mustard, paprika, coriander, and red pepper are preferable which are food containing a large amount of proteins containing an amino acid sequence having at least 20% of an sequence identity with an amino acid sequence of Bet V1 and/or Bet V2, which is a main antigen of the Betula alba pollen, because about half number of people contracting the Betula alba pollinosis develop the Class 2 food allergy. As the food having the Class 2 food allergens in the present invention, particularly preferred is soybean, whose annual consumption is high and which is reported to show a serious allergy symptom such as anaphylactic shock when a person contracting the Betula alba pollinosis takes it. The food having the Class 2 food allergens may be used alone or as a mixture of two or more kinds.

Further, the food having the Class 2 food allergens used in the present invention may include extracts obtained by extraction with water, hot water, or an organic solvent capable of using for food; juice extractions; non-concentrates grinded, pulverized, or treated with an enzyme; concentrates; diluted products; and dried products of the vegetables and the fruits listed above.

In the present invention, an optional component may be suitably added to the food having the Class 2 food allergens. The optional component may include saccharide, yeast extract, meat extract, vitamins, inorganic salts, peptides, amino acids, and the like.

The manufacturing method of the present invention is explained in detail below.

The manufacturing method of the present invention contains a step (a) in which at least lactic acid bacteria having a leucine aminopeptidase activity of 75 units or more but 720 units or less and a bivalent metal compound are added to the food having the Class 2 food allergens, and the resulting food is fermented while the pH thereof is adjusted to 4.0 or more but less than 8.5.

The leucine aminopeptidase activity in the present invention can be measured in accordance with a method of Matsutani et. al. (J. Med. Technol., 11, 300, 1967) wherein a case in which a difference in an absorbance at 540 nm between reaction liquid and a blank per g of wet bacterial cells of the lactic acid bacteria (a difference in an absorbance at 540 nm/wet bacterial cells (g)) is 1 is defined as 1 unit.

The lactic acid bacteria used in the manufacturing method of the present invention are lactic acid bacteria having a specific leucine aminopeptidase activity, and the leucine aminopeptidase activity is 75 units or more, preferably 77 units or more, more preferably 166 units or more, still more preferably 368 units or more. The upper limit of the leucine aminopeptidase activity is less than 720 units, preferably 719 units or less, more preferably 589 units or less. When the leucine aminopeptidase activity is less than 75 units, undesirably the Class 2 food allergens are not decomposed or the fermentation time for the decomposition of the Class 2 food allergens is too long. When the leucine aminopeptidase activity is 720 units or more, the obtained fermented food may sometimes undesirably be bitter.

The lactic acid bacteria used in the manufacturing method of the present invention is not particularly limited so long as the lactic acid bacteria has the leucine aminopeptidase activity within the range described above, and may include, for example, lactic acid bacteria belonging to Lactobacillus, Lactococcus, Leuconostoc, Pediococcus, Enterococcus, Streptococcus, Bacillus, and Bifidobacterium, and the like.

More specific examples may include followings:

(1) Lactobacillus helveticus K-4 strain (which was deposited with International Patent Organism Depositary, Fermentation Research Institute, Agency of Industrial Science and Technology, as FERM P-12249 on May 15, 1991);
(2) Pediococcus acidilactici R037 strain (which was deposited with National Institute of Technology and Evaluation Patent Microorganisms Depositary (NPMD), 2-5-8, Kazusakamatari, Kisarazu-shi, Chiba-ken, 292-0818, Japan, as a deposit number NITE BP-900 on Feb. 10, 2010);
(3) Pediococcus sp. 379 strain (which was deposited with National Institute of Technology and Evaluation Patent Microorganisms Depositary (NPMD), 2-5-8, Kazusakamatari, Kisarazu-shi, Chiba-ken, 292-0818, Japan, as a deposit number NITE P-01773 on Dec. 4, 2013, and was transferred to the international depositary authority under the provisions of the Budapest Treaty as a deposit number NITE BP-01773 on Nov. 17, 2014);
(4) Pediococcus sp. 380 strain (which was deposited with National Institute of Technology and Evaluation Patent Microorganisms Depositary (NPMD), 2-5-8, Kazusakamatari, Kisarazu-shi, Chiba-ken, 292-0818, Japan, as a deposit number NITE P-01772 on Dec. 4, 2013, and was transferred to the international depositary authority under the provisions of the Budapest Treaty as a deposit number NITE BP-01772 on Nov. 17, 2014);
(5) Streptococcus sp. 462 strain (which was deposited with National Institute of Technology and Evaluation Patent Microorganisms Depositary (NPMD), 2-5-8, Kazusakamatari, Kisarazu-shi, Chiba-ken, 292-0818, Japan, as a deposit number NITE P-01771 on Dec. 4, 2013, and transferred to the international depositary authority under the provisions of the Budapest Treaty as a deposit number NITE BP-01771 on Nov. 17, 2014); and the like.

The bivalent metal compound used in the manufacturing method of the present invention may include compounds containing any of alkaline earth metals, metals of Group 11 in the periodic table, and metals of Group 12 in the periodic table. Of these, magnesium compounds such as magnesium acetate, magnesium carbonate, magnesium stearate, magnesium oxide, magnesium silicate, and trimagnesium phosphate; calcium compounds such as calcium citrate, calcium carbonate, calcium dihydrogen pyrophosphate, tricalcium phosphate, calcium stearate, and calcium silicate; and zinc compounds such as zinc gluconate and zinc sulfate are preferable, because they can be usually taken as food. Instead of the bivalent metal compound, at least one food product having a compound of a metal selected from the group consisting of calcium, magnesium, and zinc in a high content may be added.

In the present invention, the bivalent metal compound is added in an amount of 2 mmol/L or more, preferably 20 mmol/L or more, more preferably 40 mmol/L or more, still more preferably 60 mmol/L or more, particularly preferably 80 mmol/L or more, relative to the food having the Class 2 food allergens, which is the starting material. The upper limit of the amount of the bivalent metal compound added is 1 mol/L or less, preferably 300 mmol/L or less, more preferably 150 mmol/L or less. When the bivalent metal ion-containing compound is added in an amount of less than 2 mmol/L, the Class 2 food allergens are undesirably insufficiently decomposed. When the bivalent metal compound is added in an amount of more than 1 mol/L, the taste undesirably becomes worse, for example, bitter taste peculiar to the bivalent metal ion, or rough food texture appears.

When the amount of the bivalent metal compound added is measured, the food having the Class 2 food allergens is in the state of a liquid composition for fermentation of the food by the lactic acid bacteria.

In the step (a) in the present invention, the food having the Class 2 food allergens can be previously sterilized before the addition of the lactic acid bacteria or the bivalent metal compound. The sterilization method may be appropriately selected depending on the kind of the food used, and may include, for example, but is not limited to, high temperature sterilization methods such as UHT (an ultrahigh temperature sterilization), retort sterilization methods, sterilization methods with electromagnetic wave, high temperature vacuum sterilization methods, ozone sterilization methods, sterilization methods using electrolyzed water, indirect heat sterilization methods, and the like.

In the step (a) in the present invention, the fermentation temperature is not particularly limited so long as the temperature is suitable for the growth of the lactic acid bacteria, and the fermentation temperature is, for example, from 15 to 45° C., preferably from 25 to 40° C., more preferably from 30 to 37° C.

In the step (a) in the present invention, the pH in the fermentation of the food having the Class 2 food allergens by adding the lactic acid bacteria thereto is 4.0 or more, preferably 4.4 or more, more preferably 5.5 or more. The upper limit of the pH of the food having the Class 2 food allergens in the step (a) in the present invention is less than 8.5, more preferably 7.5 or less, still more preferably 6.5 or less. When the fermentation liquid has a pH of less than 4.0, undesirably the leucine aminopeptidase activity becomes weaker and the desired fermented food composition may not sometimes be obtained. When the pH of the fermentation liquid has a pH of 8.5 or more, undesirably the proliferative property of the lactic acid bacteria is deteriorated and the desired fermented food composition may not sometimes be obtained.

The pH adjustment in the step (a) in the present invention may be performed as necessary so that the pH of the food is 4.0 or more but less than 8.5 during the fermentation. When the pH is adjusted, the compound used is not particularly limited so long as it can be used for food, and it is possible to use a bivalent metal compound, sodium hydroxide, sulfuric acid, ammonia, citric acid, lactic acid, and the like, because they can be taken as the food. These compounds may be used in combination. The bivalent metal compound, which can be used for the food, may include magnesium compounds such as magnesium acetate, magnesium carbonate, magnesium stearate, magnesium oxide, magnesium silicate, and trimagnesium phosphate; calcium compounds such as calcium citrate, calcium carbonate, calcium dihydrogen pyrophosphate, tricalcium phosphate, calcium stearate, and calcium silicate; and zinc compounds such as zinc gluconate and zinc sulfate. The method for adjusting the pH is not particularly limited, and may be a method in which a pH of the food is measured with a pH electrode and automatic supply is performed or a method in which an insoluble bivalent metal compound is previously added in a neutral range such as calcium carbonate or magnesium carbonate before the fermentation.

The fermentation time in the step (a) in the present invention may be appropriately decided depending on the kind and the growth state of the lactic acid bacteria and is not particularly limited. Specifically, the time is preferably 8 hours or more but 36 hours or less, more preferably 8 hours or more but 24 hours or less, still more preferably 12 hours or more but 24 hours or less. When the fermentation time is 8 hours or more but 36 hours or less, the Class 2 food allergens can be sufficiently decomposed, and the taste becomes better.

In the step (a), it is enough that the fermentation is completed for the fermentation time described above, but the fermentation time may be set at a time necessary for decreasing the Class 2 food allergens in a content of 40% or more relative to those before the fermentation. The amount of the Class 2 food allergens in the food before the fermentation or the fermented food composition may be measured according to a method described in Examples described below.

The manufacturing method of the present invention further contains the step (b) in which the fermented food composition, obtained by the fermentation in the step (a), is recovered.

According to the recovery in the manufacturing method of the present invention, the fermented food composition may be filled in a container as it is or after the composition is subjected to a treatment which is usually used for food, such as sterilization or homogenization. If necessary, a concentration, such as centrifugal separation, squeezing, or filtration, or drying, such as lyophilization or spray-drying, may be performed. In order to decrease a specific substance or concentrate it, a separation treatment using an ion-exchange membrane, an extraction treatment using a solvent, or the like may also be performed. The method for manufacturing a fermented food composition of the present invention may be carried out in the same factory or may be carried out in separated factories per step.

The fermented composition, obtained by the manufacturing method of the present invention, has the Class 2 food allergens in a remarkably decreased content compared to that of the starting food, is tasty because of the fermentation by the lactic acid bacteria, and thus can be taken as it is. If necessary, other starting materials usually used for food may be added. The other starting materials usually used for food may include, for example, an excipient, a disintegrator, an emulsifier, a stabilizer, a buffering agent, a perfume, and the like. They may be appropriately mixed according to the form of use by those skilled in the art, and the amount of the other starting materials added may be designed according to the product form by those skilled in the art.

The fermented food composition, obtained by the manufacturing method of the present invention, can be used for food, functional food, medicine, feed, and the like.

For example, when the food containing the fermented food composition is daily taken as food, the form thereof is not particularly limited, and may include common form of food such as baked goods, cakes, pies, cookies, Japanese confectioneries, snack foods, fried confectioneries, chocolate and chocolate confectioneries, rice confectioneries, roux, sauce, Japanese sauce, toppings, ice confectioneries, noodles, bakery mixes, fried food, meat processed products, other processed products such as tofu and konnyaku, fish paste products, frozen food such as frozen entrees, frozen livestock food, and frozen agricultural products, cooked rice, jam, cheese, cheese food, cheese-like food, chewing gum, candies, fermented milk, canned food, beverages, and the like. When it is used as functional food or medicine, the dosage form thereof is not particularly limited, and it may include, for example, capsules, syrups, tablets, pills, powders, granules, drinkable preparations, injections, fluid infusions, nasal drops, eye drops, suppositories, patches, sprays, and the like. They can be prepared by appropriately adding, for example, an excipient, a disintegrator, a lubricant, a binding agent, an antioxidant, a coloring agent, a deflocculating agent, an absorption promoter, solubilizer, and a stabilizer, in addition to a pharmaceutically acceptable preparation. When it is used as feed, starting materials usually used for mixed feed may be appropriately added according to the kind, the stage of growth, or the rearing environment, such as a local area, of an animal. The starting material may include, for example, grains and processed grains (corn, milo, barleycorn, wheat, rye, oats, millet, wheat flour, wheat germ powder, and the like); chaff and bran (wheat bran, rice bran, corn gluten feed, and the like); plant origin oil cakes (soybean oil cake, sesame oil cake, cottonseed oil cake, peanut oil cake, sunflower oil cake, safflower oil cake, and the like); animal origin starting materials (skim milk, fish meal, meat and bone meal, and the like); minerals (calcium carbonate, calcium phosphate, sodium chloride, silicic acid anhydride, and the like); vitamins (vitamin A, vitamin D, vitamin E, vitamin K, vitamin B1, vitamin B2, vitamin B6, vitamin B12, calcium pantothenate, nicotinic acid amide, folic acid, and the like); amino acids (glycine, methionine, and the like); yeasts such as beer yeast; fine powders of an inorganic substance (crystalline cellulose, talc, silica, white mica, zeolite, and the like); and the like. The feed in the present invention may be mixed with additives for feed such as an excipient, an extender, a binding agent, a thickener, an emulsifier, a coloring agent, a perfume, a food additive, and a seasoning, and if necessary other components (such as an antibiotic, a sterilizer, an insecticide, a preservative, and the like). The form of the feed is not particularly limited, and it may include, for example, powders, granules, a paste, pellets, capsules (hard capsules and soft capsules), tablets, and the like. Animals to which the feed is fed are not particularly limited, and may include, for example, domestic animals such as cattle, horses, pigs, and sheep; domestic fowls such as chickens (including both of broilers and hens), turkeys, and ducks; experimental animals such as mice, rats, and guinea pigs; pets such as dogs and cats; and the like.

### EXAMPLES

In order to specifically explain the present invention, detailed examples are listed below, but the present invention is not limited thereto.

### <Preparation Method of Fermented Soybean Milk>

Commercial dried soybean was washed with water, and was immersed in a water in an amount of 9 times for 3 hours. After that, it was pulverized in a mixer into a paste, which was filtered through a gauze to prepare soybean milk. To the soybean milk were added 1% of glucose and 1.5% (150 mmol/L) of calcium carbonate, and the mixture was sterilized at 90° C. for 15 minutes. Then, lactic acid bacteria were inoculated, and fermentation was performed at 37° C. for 24 hours with stirring.

### <Calculation Method of Decreasing Rate of Glym4>

100 μL of the soybean milk, which was 100-fold diluted with PBS (10 mM of phosphate buffer and 150 mM of NaCl, pH7.4), was added to “96-well ELISA plate” (manufactured by Iwaki Co., Ltd.) before and after the fermentation, and it was allowed to stand at 37° C. for 30 minutes to fix it on the plate. After the soybean milk obtained before and after the fermentation was removed, 200 μL of a blocking agent “BlockingOne” (a trade name, manufactured by Nacalai Tesque, Inc.), which was 5-fold diluted with distilled water, was added to each well, and the mixture was allowed to stand at room temperature for one hour. After the each well was washed with washing buffer “PBST” (10 mM of phosphate buffer, 150 mM of NaCl, and 0.05% Tween® 20, pH7.4) three times, 50 μL of Glym4-specific rabbit antisera, which were 1000-fold diluted with an antibody diluent “Can Get Signal® Solution 1” (a trade name, manufactured by Toyobo Co., Ltd.), were added to the each well, which was allowed to stand at 37° C. for one hour.

After the each well was washed with PBST three times, 50 μL of peroxidase-labeled goat anti-rabbit IgG antibodies (manufactured by Thermo Fisher Scientific Inc.), which were 1000-fold diluted with antibody diluent “Can Get Signal® Solution 2” (a trade name, manufactured by Toyobo Co., Ltd.), were added to the each well, which was allowed to stand at 37° C. for one hour. After the each well was washed with PBST five times, 100 μL of “ELISA POD substrate TMB kit” (a trademark, manufactured by Nacalai Tesque, Inc.) was added to the each well, which was allowed to stand at room temperature for 15 minutes (a color reaction). Then, 100 μL of 1M sulfuric acid was added to the each well (stopping of the coloring), and an absorbance at 450 nm was measured. Using the absorbance in the soybean milk before the fermentation and the absorbance in the soybean milk after the fermentation, a decreasing rate of Glym4 was calculated according to the equation (1):

$$\begin{matrix} [ Equation 1 ] & \\ \begin{matrix}Decreasing rate of \\ Glym 4\end{matrix} ( \% ) = \{ 1 - \frac{[ \begin{matrix}Absorbance of soybean milk at \\ 540 nm before fermentation\end{matrix} ]}{[ \begin{matrix}Absorbance of soybean milk at \\ 540 nm after fermentation\end{matrix} ]} \} \times 100 & Equation ( 1 )\end{matrix}$$

### <Calculation Method of Leucine Aminopeptidase Activity of Lactic Acid Bacteria>

Lactic acid bacteria were cultured in 10 mL of an MK-1 medium (0.5% of yeast extract, 1% of peptone, and 1% of glucose, pH 6.8), which had been sterilized, at 37° C. for 24 hours, and bacterial cells were collected by centrifugal separation. The bacterial cells were washed with 30 mL of 50 mM phosphate buffer (0.4 mM of EDTA-3 mM of DTT, pH16.2), and the centrifugal separation was performed again to obtain wet bacterial cells. The wet bacterial cells were weighed by using an electronic balance (manufactured by Sartorius) to measure a weight of the wet bacterial cells. After that, a suspension in which the bacterial cells were suspended in 30 mL of 50 mM phosphate buffer was subjected to a leucine aminopeptidase activity measurement. To 0.1 mL of the bacterial cell suspension was added 2 mL of 0.2 mM L-leucine-β-naphthylamide solution (L-Leucine-β-naphthylamide/50 mM of phosphate buffer), which was reacted with enzymes at 37° C. for one hour. To the enzyme reaction liquid was added 1 mL of 0.23N HCl/ethanol solution to stop the enzyme reaction. A 0.06% of p-dimethylaminocinnamaldehyde/ethanol solution was added thereto, which was incubated at 37° C. for 30 minutes, and then an absorbance was measured at 540 nm to obtain the absorbance of the reaction liquid. An absorbance of a blank was measured in the same operation as above except that 2 mL of 50 mM phosphate buffer was used instead of 2 mL of the 0.2 mM L-leucine-β-naphthylamide solution. Using the obtained absorbance of the blank and that of the reaction liquid at 540 nm, and weight of the wet bacterial cells, the leucine aminopeptidase activity of the lactic acid bacteria was calculated according to the equation (2):

$$\begin{matrix} [ Equation 2 ] & \\ \begin{matrix}Leucine aminopeptidase \\ activity of lactic acid \\ bacteria\end{matrix} ( unit ) = \frac{\begin{matrix}[ \begin{matrix}Absorbance of reaction \\ liquid at 540 nm\end{matrix} ] - \\ [ \begin{matrix}Absorbance of blank \\ at 540 nm\end{matrix} ]\end{matrix}}{[ \begin{matrix}Weight of \\ bacterial \\ cells\end{matrix} ]} \times \frac{[ \begin{matrix}Weight of \\ bacterial \\ cells\end{matrix} ] + 30}{0.1} & Equation ( 2 )\end{matrix}$$

### <Selection of Lactic Acid Bacteria>

From the lactic acid bacteria separated from the food, lactic acid bacteria having a leucine aminopeptidase activity of 50 units or more were selected by using the activity measurement method described above.

### <Sensory Evaluation of Fermented Soybean Milk>

The fermented soybean, which was adjusted to a temperature of 10° C., was tasted by 5 panelists, and sensory evaluations about soybean odor and taste were performed. The soybean odor was evaluated as follows: A case where there was no soybean odor was evaluated as “◯”, a case where there was slight soybean odor was evaluated as “Δ”, and a case where there was soybean odor was evaluated as “x”. The taste was evaluated as follows: A case where it was tasty was evaluated as “◯”, a case where it was not so tasty was evaluated “Δ”, and a case where it was not tasty was evaluated as “x”.

### Example 1

### Decreasing Rate of Glym4 in Lactic Acid Bacteria

A fermented soybean milk was prepared using lactic acid bacteria, Lactobacillus delbrueckii subsp. lactis KLAB-4 strain (hereinafter referred to as “LAB4 strain”), Lactobacillus helveticus K-4 strain (hereinafter referred to as K4 strain), and Pediococcus acidilactici R037 strain (hereinafter referred to as R037 strain), according to the preparation method of the fermented soybean milk described above. Glym4 in the fermented soybean milk was measured according to the measurement method of Glym4 described above. The decreasing rate of Glym4 was obtained by the above equation, and the results are shown in Table 1.

Lactobacillus delbrueckii subsp. lactis KLAB-4 strain was deposited with National Institute of Technology and Evaluation Patent Microorganisms Depositary (NPMD), 2-5-8, Kazusakamatari, Kisarazu-shi, Chiba-ken, 292-0818, Japan, as a deposit number NITE P-394 on Aug. 9, 2007, and transferred to the international depositary authority under the provisions of the Budapest Treaty as a deposit number NITE BP-394 on Sep. 22, 2008.

TABLE 1

| Lactic acid bacteria | Decreasing rate of Glym4 (%) |
|---|---|
| LAB4 strain | 0 |
| K4 strain | 40 |
| R037 strain | 80 |

From Table 1, it was found that the decreasing rate of Glym4 varied depending on the lactic acid bacteria used in the fermentation.

### Example 2

### Leucine Aminopeptidase Activity of Lactic Acid Bacteria Used in Example 1

Leucine aminopeptidase activities of theLAB4 strain, the K4 strain, and the R037 strain were measured according to the measurement method of the leucine aminopeptidase activity of the lactic acid bacteria described above. The results are shown in Table 2.

TABLE 2

| Lactic acid bacteria | Leucine aminopeptidase activity (unit) |
|---|---|
| LAB4 strain | 48.2 |
| K4 strain | 718.6 |
| R037 strain | 368.3 |

From Table 2, the LAB4 strain having a decreasing rate of Glym4 of 0% had a leucine aminopeptidase activity of 48.2 units, and the K4 strain having a decreasing rate of Glym4 of 40% had a leucine aminopeptidase activity of 718.6 units, and R037 strain having a decreasing rate of Glym4 of 80% had a leucine aminopeptidase activity of 368.3 units.

### Example 3

### Screening of Lactic Acid Bacteria Having Leucine Aminopeptidase Activity of 50 Units or More

Using 15 strains of lactic acid bacteria separated from food materials as a subject, leucine aminopeptidase of each kind of the lactic acid bacteria was measured according to the measurement method of the leucine aminopeptidase activity of the lactic acid bacteria described above, and bacterial strains having a leucine aminopeptidase activity of 50 units or more, Pediococcus sp. 380 strain (hereinafter referred to as 380 strain), Pediococcus sp. 379 strain (hereinafter referred to as 379 strain), and Streptococcus sp. 462 strain (hereinafter referred to as 462 strain) were obtained. The leucine aminopeptidase activities of the three kinds of lactic acid bacteria strains are shown in Table 3.

TABLE 3

| Lactic acid bacteria | Leucine aminopeptidase activity (unit) |
|---|---|
| 380 strain | 77.4 |
| 379 strain | 166.1 |
| 462 strain | 588.6 |

### Example 4

### Decreasing Rate of Glym4 in Lactic Acid Bacteria Screened in Example 3

Using the 380 strain, the 379 strain, and the 462 strain, fermented soybean milk was prepared according to the method of preparing the fermented soybean milk described above, and the decreasing rate of Glym4 was obtained. The results are shown in Table 4.

TABLE 4

| Lactic acid bacteria | Decreasing rate of Glym4 (%) |
|---|---|
| 380 strain | 50 |
| 379 strain | 70 |
| 462 strain | 70 |

From Table 4, the 380 strain having a leucine aminopeptidase activity of 77.4 units had a decreasing rate of Glym4 of 50%, the 379 strain and the 462 strain, having, respectively, leucine aminopeptidase activities of 166.1 units and 588.6 units, had a decreasing rate of Glym4 of 70%.

It was found accordingly from the results of Example 1 to Example 4 that the lactic acid bacteria had a decreasing rate of Glym4 of 40% or more when the leucine aminopeptidase activity was 75 units or more but less than 720 units.

### Example 5

### Study of Metal Compound

To soybean milk, prepared from commercial dried soybean, were added 1% of glucose and, as metal compounds, calcium carbonate, magnesium carbonate, or sodium hydrogen carbonate respectively in an amount of 1.5% (150 mmol/L), 1.7% (150 mmol/L), or 1.7% (150 mmol/L), and the mixture was sterilized at 90° C. for 15 minutes. Then, the R037 strain was inoculated, and the mixture was fermented at 37° C. for 24 hours with stirring to prepare fermented soybean milk. The content of Glym4 in each fermented soybean milk was measured, which was compared to that of fermented soybean milk prepared in the same manner as above except that the metal compound was not added. The results are shown in Table 5.

TABLE 5

| Metal compound | Decreasing rate of Glym4 (%) |
|---|---|
| Calcium carbonate | 80 |
| Magnesium carbonate | 80 |
| Sodium hydrogen carbonate | 0 |
| None | 0 |

From Table 5, when calcium carbonate or magnesium carbonate was used as the metal compound, the decreasing rate of Glym4 was 80%, and in a case of addition of sodium hydrogen carbonate or addition of no metal compound, the content of Glym4 was not decreased. From the above, it was found that the bivalent metal compound was necessary for decrease of the content of Glym4.

### Example 6

### Amount of Bivalent Metal Compound Added (Calcium Carbonate)

To soybean milk, prepared from commercial dried soybean, were added 1% of glucose, and calcium carbonate in a content of 0.02% (2 mmol/L), 0.2% (20 mmol/L), 0.4% (40 mmol/L), 0.6% (60 mmol/L), 0.8% (80 mmol/L), 1.5% (150 mmol/L), 3.0%(300 mmol/L), or 10% (1000 mmol/L), and the mixture was sterilized at 90° C. for 15 minutes. Then, the R037 strain was inoculated, and the soybean milk having a concentration of the bivalent metal compound of 0.02 to 0.4% was fermented at 37° C. for 24 hours with stirring while the pH was maintained at 5.5 with a 25% sodium hydroxide solution, or the soybean milk having a concentration of the bivalent metal compound of 0.6 to 10% was fermented at 37° C. for 24 hours with stirring without control of the pH, whereby each fermented soybean milk was prepared. The content of Glym4 in the fermented soybean milk was measured, and the decreasing rate of Glym4 was calculated. The decreasing rate of Glym4 and the pH after the fermentation are shown in Table 6.

TABLE 6

| Amount of calcium carbonate | Decreasing rate | |
|---|---|---|
| added (mmol/L) | of Glym4 (%) | pH |
| 2 | 30 | 5.5 |
| 20 | 80 | 5.5 |
| 40 | 80 | 5.5 |
| 60 | 80 | 5.5 |
| 80 | 80 | 5.5 |
| 150 | 80 | 5.8 |
| 300 | 80 | 6.0 |
| 1000 | 80 | 6.1 |

From Table 6, it was found that when the fermentation was performed by adding calcium carbonate in an amount of 20 mmol/L or more and maintaining the pH at 5.5 or more, the decreasing rate of Glym4 was 80% and Glym4 was sufficiently decomposed. It was also found that when the amount of calcium carbonate added was 60 mmol/L or more, the pH could be maintained at 5.5 or more even if the pH was not controlled.

### Example 7

### Study of pH of Food During Fermentation

To soybean milk, prepared from commercial dried soybean, were added 1% of glucose and 0.2% (20 mmol/L) of calcium carbonate, and the mixture was sterilized at 90° C. for 15 minutes. Then, the R037 strain was inoculated, and the fermentation was performed with a 25% sodium hydroxide solution at 37° for 24 hours with stirring while the pH was maintained at 5.5, 6.5, 7.5, or 8.5, whereby fermented soybean milk was prepared. The content of Glym4 in the fermented soybean milk prepared at each controlled pH was measured, and it was compared to that of fermented soybean milk prepared in the same manner as above except that the pH control was not performed. The results are shown in Table 7.

TABLE 7

| pH | Decreasing rate of Glym4 (%) |
|---|---|
| 4.4 | 20 |
| 5.5 | 80 |
| 6.5 | 80 |
| 7.5 | 80 |
| 8.5 | 10 |

From Table 7, it was found that when the pH was maintained at 5.5 to 7.5, the decreasing rate of Glym4 was 80%, and thus it was preferable that the pH was controlled within a range of 5.5 to 7.5 during the fermentation.

### Example 8

### Fermentation Time and Sensory Evaluation

To commercial pure soybean milk were added 1% of glucose and 0.6% (60 mmol/L) of calcium carbonate, and the mixture was sterilized at 90° C. for 15 minutes. The R037 strain was inoculated, and then the fermentation was performed with stirring at 37° C. for 8 hours, 12 hours, 24 hours, 36 hours, or 72 hours, whereby each fermented soybean milk was prepared.

The content of Glym4 of the each fermented soybean milk was measured, and it was compared to that of the soybean milk which was not fermented. In addition, each fermented soybean milk and soybean milk which was not fermented was subjected to the sensory evaluation as described above. The odor and the taste were evaluated according to a three-point method (x: inferior, Δ: average, ◯: good). The results of the decreasing rate of Glym4 and the sensory evaluation are shown in Table 8. The soybean milk having a decreasing rate of Glym4 of 40% or more and at least one of the “odor” and the “taste” of “◯” was evaluated as an accepted product.

TABLE 8

| | Fermentation | Decreasing rate | | |
|---|---|---|---|---|
| Starting material | time | of Glym4 | Odor | Taste |
| Commercial pure | 0 h | 0 | ◯ | ◯ |
| soybean milk | 8 h | 80 | ◯ | ◯ |
| | 12 h | 80 | ◯ | ◯ |
| | 24 h | 80 | ◯ | Δ |
| | 36 h | 80 | Δ | Δ |
| | 72 h | 90 | X | X |

From Table 8, it was found that when the commercial pure soybean milk was fermented for 8 hours, the decreasing rate of Glym4 was 80%. In addition, as a result of the sensory evaluation, it was found that when the fermentation time was 8 hours to 24 hours, the odor and the taste of the fermented soybean milk were good.

### DEPOSIT NUMBER

FERM P-12249, NITE BP-394, NITE BP-900, NITE BP-01773, NITE BP-01772, NITE BP-01771

1. A manufacturing method for manufacturing a fermented food composition by fermenting food having Class 2 food allergens, comprising the following steps (a) and (b):
(a) a step of adding at least lactic acid bacteria having a leucine aminopeptidase activity of 75 units or more to 720 units or less and a bivalent metal compound to food having Class 2 food allergens and fermenting the resulting food while adjusting the pH of the food to 4.0 or more to less than 8.5; and
(b) a step of recovering a fermented food composition obtained by the fermenting in step (a) fermentation.

2. The manufacturing method according to claim 1, wherein the bivalent metal compound is at least one compound selected from the group consisting of a magnesium compound, a calcium compound, and a zinc compound.

3. The manufacturing method according to claim 1, wherein the bivalent metal compound is added in an amount of 2 mmol/L or more to less than 1 mol/L.

4. The manufacturing method according to claim 3, wherein the bivalent metal compound is added in an amount of 20 mmol/L or more but 150 mmol/L or less.

5. The manufacturing method according to claim 1, wherein the Class 2 food allergen is a protein comprising an amino acid sequence having 20% or more of a sequence identity with an amino acid sequence of BetV1 and/or or BetV2 or both.

6. The manufacturing method according to claim 1, wherein the food having the Class 2 food allergens is soybean and/or or processed food of soybean or both.

7. The manufacturing method according to claim 1, wherein the lactic acid bacteria are is at least one of bacteria selected from the group consisting of lactic acid bacteria belonging to Lactobacillus, Lactococcus, Leuconostoc, Pediococcus, and Enterococcus.

8. The manufacturing method according to claim 1, wherein the fermentation is performed for 8 hours or more to 36 hours or less.

9. A fermented food composition obtained by the manufacturing method according to claim 1.

10. Food comprising the fermented food composition according to claim 9.

11. Feed comprising the fermented food composition according to claim 9.

12. The manufacturing method according to claim 2, wherein the bivalent metal compound is added in an amount of 2 mmol/L or more to less than 1 mol/L.

13. The manufacturing method according to claim 2, wherein the bivalent metal compound is added in an amount of 20 mmol/L or more but 150 mmol/L or less.

14. The manufacturing method according to claim 2, wherein the Class 2 food allergen is a protein comprising an amino acid sequence having 20% or more of a sequence identity with an amino acid sequence of BetV1 or BetV2 or both.

15. The manufacturing method according to claim 3, wherein the Class 2 food allergen is a protein comprising an amino acid sequence having 20% or more of a sequence identity with an amino acid sequence of BetV1 or BetV2 or both.

16. The manufacturing method according to claim 4, wherein the Class 2 food allergen is a protein comprising an amino acid sequence having 20% or more of a sequence identity with an amino acid sequence of BetV1 or BetV2 or both.

17. The manufacturing method according to claim 2, wherein the food having the Class 2 food allergens is soybean or processed food of soybean or both.

18. The manufacturing method according to claim 3, wherein the food having the Class 2 food allergens is soybean or processed food of soybean or both.

19. The manufacturing method according to claim 4, wherein the food having the Class 2 food allergens is soybean or processed food of soybean or both.

20. The manufacturing method according to claim 5, wherein the food having the Class 2 food allergens is soybean or processed food of soybean or both.


SEQUENCE LISTING (4 sequences)

SEQ ID NO: 1 - protein, 160 aa, Betula platyphylla
MGVFTYESETTSAIPPAKLFKAFVLDADNLIPKVAPHAIKSAEIIEGNGGPGTIKKITFGEGSQFKYVKHRIDEVDHANFTYGYSVIEGDALSEVLEKISYEIKIVASHDGGSVLKSTSKYHTKGAHEIKEEQIKAGKEKAAGLFKAIEAYLLAHSDLYN

SEQ ID NO: 2 - protein, 133 aa, Betula platyphylla
MSWQTYVDEHLMCDIDGQGEELAASAIVGHDGSVWAQSSSFPQFKPQEITGIMKDFEEPGHLAPTGLHLGGIKYMVIQGEAGAVIRGKKGSGGITIKKTGQALVFGIYEEPVTPGQCNMVVERLGDYLIDQGL

SEQ ID NO: 3 - protein, 158 aa, soybean
MGVFTFEDEINSPVAPATLYKALVTDADNVIPKALDSFKSVENVEGNGGPGTIKKITFLEDGETKFVLHKIESIDEANLGYSYSVVGGAALPDTAEKITFDSKLVAGPNGGSAGKLTVKYETKGDAEPNQDELKTGKAKADALFKAIEAYLLAHPDYN

SEQ ID NO: 4 - protein, 131 aa, soybean
MSWQAYVDDHLLCEIEGNHLTHAAIIGQDGSVWAQSTNFPQFKPEEITAINNDFNEPGSLAPTGLYIGGTKYMVIQGEPGAVIRGKKGPGGVTVKKTGAALIIGIYDEPMTPGQCNMVVERLGDYLIDQGL